(19) United States
(12) Patent Application Publication
(10) Pub. No.: US 2019/0073701 A1
(43) Pub. Date: Mar. 7, 2019

(54) VEHICLE VALUATION MODEL BASED ON VEHICLE TELEMETRY

(71) Applicant: Tesloop, Inc., Culver City, CA (US)

(72) Inventors: Haydn Ramanna Sonnad, Los Angeles, CA (US); Hammad Hai, Catonsville, MD (US)

(21) Appl. No.: 16/124,027

(22) Filed: Sep. 6, 2018

Related U.S. Application Data
(60) Provisional application No. 62/554,955, filed on Sep. 6, 2017.

(51) Int. Cl. G06Q 30/02; G06Q 10/06

(52) U.S. Cl. CPC G06Q 30/0278; G06Q 20/065; G06Q 2220/00; G06Q 10/067

(57) ABSTRACT

Systems and methods are presented for gathering data from various sources, vehicle and non-vehicle, store this data on a blockchain record that is verified and attached to the vehicle, and then create a predictive valuation model that is updated in real time and can be used to guide financial transactions such as lease payments, financing terms, sale terms and such. By storing the vehicle's telemetric and related data on a blockchain, the presently disclosed systems and methods eliminate the requirement for a third-party to facilitate or verify a transaction between parties in a financial transaction related to the vehicle.

### CROSS REFERENCE TO RELATED APPLICATION

This application claims the benefit of U.S. Provisional Patent Application No. 62/554,955 filed on Sep. 6, 2017 and titled “Vehicle Valuation Model based on Vehicle Telemetry”, the disclosure of which is incorporated herein by reference in its entirety.

### TECHNICAL FIELD

The subject matter described herein relates to vehicle valuation systems and methods, for valuing a vehicle based on vehicle telemetry, and accounting and paying for activities in real-time based on the telemetry feed of the vehicle. More particularly, the present disclosure relates to creating models to assess a vehicle's valuation based on historical including vehicle telemetry data and non-vehicle data of a time- or geographical-dependent nature related to the vehicle. The valuation can be a market valuation (i.e. sale value) or other valuation (i.e. cash-flow potential, for example).

### BACKGROUND

Currently, in the historical paradigm for automobiles, a vast majority of vehicle data was uncollectable. Recently, however, vehicles are evolving into autonomous, electric, network-connected digital computing devices. The so-called “Car 2.0” platform refers to a system of vehicles that combine autonomous driving capabilities, electric drivetrains, and digital connectivity. Vehicles with an underlying digital control architecture have a wide range of variables that are continually monitored, and data about which can be queried and collected by external programs in real time at a high frequency (i.e. multiple times per second). This provides orders of magnitude more vehicle telemetry data than analog vehicles, and enables this data to be continually gathered over the lifetime of the vehicle. They also have the ability to remotely control aspects of the vehicle, such as whether it is locked, or its maximum driving speed, through programmatic APIs.

Currently, internal combustion engine vehicles are given valuation estimates sourced from typically a very small number of variables: the model year of the vehicle, the mileage driven, the general external and internal condition, and features of the vehicle. In some cases service records are factored into this limited valuation model, as are events that trigger title changes such as accidents. The valuation of a of “Car 2.0” vehicle can be determined by much richer set of historical vehicle data.

### SUMMARY

The present disclosure describes systems and methods to gather data from various sources, vehicle and non-vehicle, store this data on a blockchain record that is verified and associated with the vehicle, and then create a predictive valuation model that is updated in real time and can be used to guide financial transactions such as lease payments, financing terms, sale terms and such. By storing the vehicle's telemetric and related data on a blockchain, the presently disclosed systems and methods eliminate the requirement for a third-party to facilitate or verify a transaction between parties in a financial transaction related to the vehicle.

In one aspect, a method, system and computer program product execute a process for valuing a vehicle. The process includes the steps of receiving, by one or more processors of a vehicle valuation system, vehicle telemetry data collected by one or more sensors associated with the vehicle, and storing, by the one or more processors, the vehicle telemetry data in a blockchain stored in a database associated with the vehicle valuation system. One or more blocks of the blockchain include a portion of the vehicle telemetry data and a timestamp associated with the collection of the vehicle telemetry data. The process further includes accessing, by the one or more processors, one or more vehicle valuation models from a model store associated with the vehicle valuation system, each of the one or more vehicle valuation models including a telemetry-based evaluation component associated with the vehicle telemetry data and a time-based evaluation component associated with the timestamp. The process further includes executing, by the one or more processors, at least one vehicle valuation model on the blockchain to generate a present value for the vehicle according to parameters associated with the at least one vehicle valuation model

In other aspects, the vehicle valuation system can receive non-vehicle data collected from third party data collection systems. The vehicle valuation system can add the non-vehicle data to the blockchain, and in some cases including a time-based event associated with a timestamp of a block of the blockchain.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, a blockchain, a peer-to-peer network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a diagram illustrating aspects of a system showing features consistent with implementations of the current subject matter; and

FIG. 2 shows a process flow diagram illustrating aspects of a method having one or more features consistent with implementations of the current subject matter.

When practical, similar reference numbers denote similar structures, features, or elements.

### DETAILED DESCRIPTION

The present disclosure describes a decentralized system for assessing the market value of a vehicle in real time, based on the creation of a predictive model that utilizes a rich set of data, historically gathered from the vehicle itself. A system and method disclosed herein utilizes telemetric data collected at a high frequency (i.e. possibly more than once per second)—encompassing data such as speed, power output, battery state, battery charging state, duration spent in various weather conditions—in combination with year, mileage, features, and condition of vehicle to create a model that depicts the market valuation of vehicles at any given moment in time. The system and method also factors in data on market transactions on vehicles to tightly correlate the model with the reality of the market, and assesses the elements of depreciation based on a multivariate set of factors. This allows the model to predict a market value of vehicle, based on a wide range of factors that contribute to depreciation, and update the model based on actual sales and other market-based transactions.

Blockchain

The purpose of utilizing blockchain in this model is to securely store and verify the vehicle's data, mitigating concern of the data being manipulated by any party. This allows the telemetry data along with other data such as service records to be stored with a car and passed across owners in an immutable form. The blockchain thus also eliminates the need for a third-party to facilitate transaction between various parties, since the data will be secure and an exact representation of the vehicle behavior commensurate effect on the vehicle value can be determined. Typical blockchain “Layer 1” smart contract platforms enable applications to facilitate payments with cryptocurrencies based the state of various contract inputs. In the case of an automobile, the inputs are given in real-time from the telemetry feed of the vehicle, and can be used to facilitate payments in real time based on behaviors such as miles-driven, or amount of battery charged used. Additionally, the data can be validated before it is committed to blocks. For instance, a large sample of people can confirm that weather data, as part of third party data, is correct for a micro payment. Any number of validation techniques can be employed.

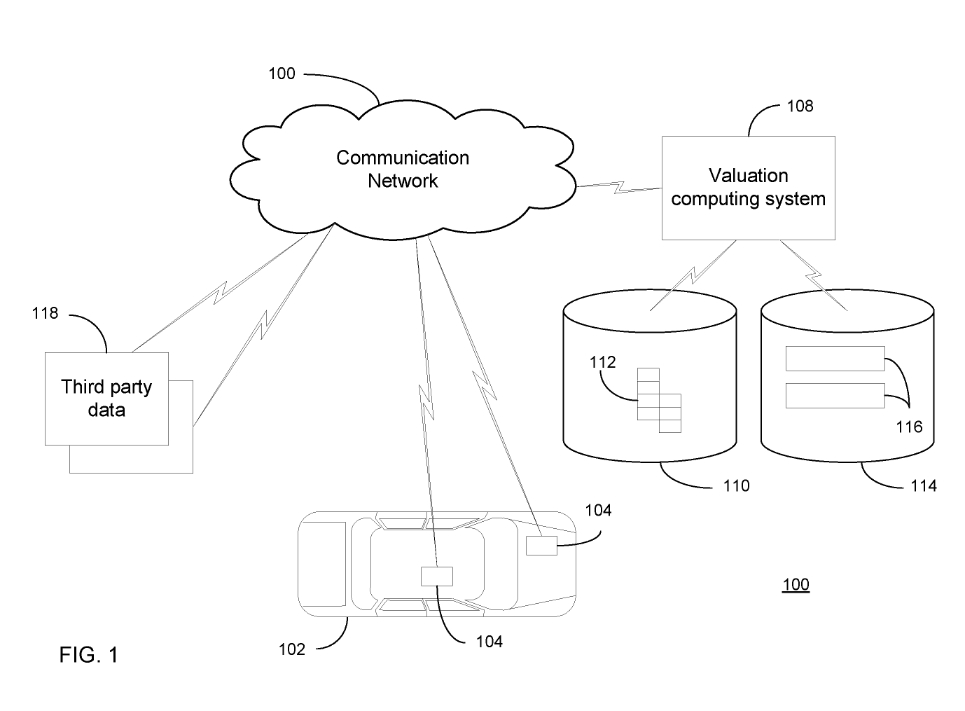

FIG. 1 illustrates a system 100 for generating an accurate value of a vehicle 102. The system 100 includes one or more sensors or monitors 104 for tracking and recording vehicle telemetry data on the vehicle 102. The sensors 104 or data collectors can include, without limitation, a speedometer, an accelerometer, a position sensor, a geolocation sensor, a pressure sensor, a temperature sensor, an onboard computer processor, or the like or any combination thereof. The sensors 104 and/or the vehicle 102 can transmit the vehicle telemetry data over a communication network 106 to a valuation system 108. The valuation system 108 can be a server computer, which in turn can be one or more distributed server computers or a distributed computing system.

The valuation system 108 can include logic, embedded in software or hardware, or a combination thereof, for executing the methods described herein. The valuation system 108 includes, or is associated with a database 110. The database 110 can be a standalone database, or a distributed database with multiple points of decentralized access. The valuation system 108 can receive the vehicle telemetry data from the sensors 104 and/or vehicle 102, and store the data in a blockchain 112 stored in the database.

The system 100 further includes a model store 114 associated with the valuation system 108. The model store 114 stores one or more valuation models 116 that are generated for execution by the valuation system 108, using data in the blockchain 112, to generate a value for the vehicle 102, as further described below.

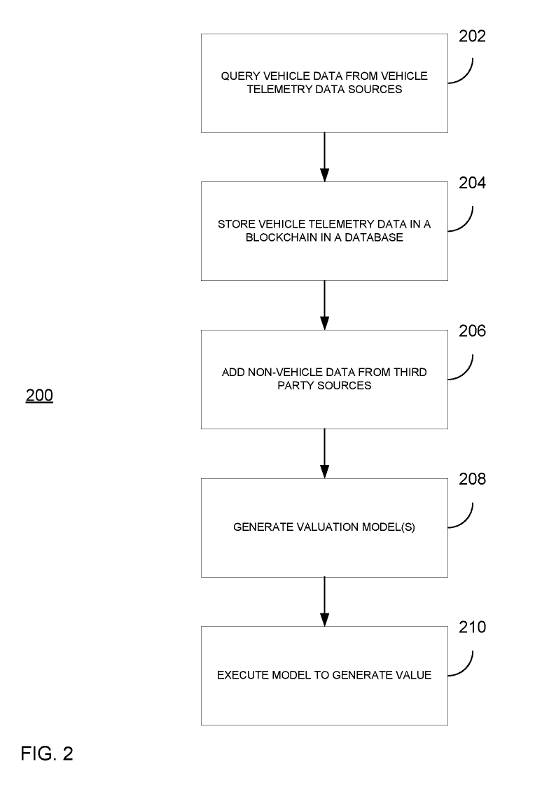

FIG. 2 is a flowchart 200 of a vehicle valuation process, in accordance with systems and methods described herein. At 202 multiple sources of vehicle telemetry data are queried and received by a vehicle valuation system. The vehicle telemetry data can be collected by one or more sensors and data collectors, such as a speedometer, an accelerometer, a position sensor, a geolocation sensor, a pressure sensor, a temperature sensor, an onboard computer processor, or the like or any combination thereof.

For example, a location of the vehicle can be periodically determined and transmitted to the vehicle valuation system. The period can be every second or less, or every day or more. In some implementations, the location data can be used to determine the depreciation/appreciation of the car being in geographic areas for X amount of time. For example, being on roads that are routinely salted during the winter time depreciates the value of the car due to corrosion. In contrast, the vehicle spending time in neutral weather may appreciate the value from a baseline value of average weather conditions for similar vehicles.

In another example, speed and power output of the vehicle can be monitored and transmitted to, or accessed by, the vehicle valuation system. For instance, when the motor is pushed heavily, such as into a full acceleration from a standstill, depending on the power of the car, this may cause stress on the motor that depreciates the value rapidly. Time spent in excess of a specific speed threshold can also result in depreciation. Other vehicle telemetry data can include total miles driven, and a state of charge or battery usage patterns. For example, charging the battery past 80% or not giving the battery rest period between intensive use can degrade the battery longevity. Total amount of charges also impacts longevity. In some instances, battery charging patterns may not reveal lowered maximum charge range immediately, and therefore, the historical patterns will affect that actual value of the vehicle, beyond the current implications of these on valuation.

In some implementations, vehicle telemetry data can include or define a vehicle state. For instance, a sensor or data collector can monitor aspects of vehicle state, such as door and window positions. Various combinations of vehicle states can be categorized into depreciation/appreciation. For example, if the sunroof is X % open, and rain sensing wipers are enabled and active, depreciation occurs due to internal water damage. Or, by measuring an actual usage of the brakes (how often were they employed and for what length of time at what speed), the system can estimate the remaining life of the brake components, and thus determine the effects of this on the vehicle valuation. By using sensor data, one could assess whether the vehicle is parked inside or outside, and thus what the commensurate depreciation would be based on parking situation and various weather factors. Also, sensor data can be used to determine if there is any likely damage to the vehicle, such as that caused by another vehicle door hitting the vehicle side body while parked with a certain speed.

Referring again to FIG. 2, at 204 the vehicle telemetry data from multiple sources is stored in a cryptographically-secure data structure in a database, such as a blockchain created and stored in a database. A blockchain or other immutable record keeping system can ensure the veracity of the data, even as the vehicle ownership changes. At 206, non-vehicle data is collected and/or transmitted to the vehicle valuation system, and added to the blockchain. The non-vehicle data can include data from third party data systems, such as weather data, temperature (which could affect battery degradation patterns), precipitation, cloudiness (which can affect a vehicle's exterior), or other environmental or time-based data. The system can include a mechanism to digitally sign non-vehicle data (such as service activities) by a third party to verify their identity and activities, and propagate details of these activities onto the vehicle database or blockchain in a secure manner.

Non-vehicle data and third-party data can be categorized and quantified in accordance with one or weighting or categorization schemes. The following are merely examples of such schemes:
Front brakes were replaced with OEM brakes ($700+ value)
New 75 kwh battery was installed of serial # X ($14 k+ value)
This specific car was filmed and featured in opening scene of James Bond Movie Release ($12 k+ value)
Recall of airbag in car was made ($900− value)
New sensor hardware suite was released with current model of the vehicle. This results in a lower value of the vehicle due to higher perceived obsolescence level
Price of new model car of same configuration was decreased by 5%, thus resulting in an immediate depreciation of the vehicle

At 208 one or more discrete valuation models are created or generated for specific types of events. For instance, to derive the depreciation value both 1) machine learning-based predictive modeling can be used to correlate multiple variables with actual market car values, and 2) specific events will have discrete valuation impacts. A comprehensive set of third party activities can be listed and rated according to their effect on depreciation/appreciation, either with a specific value or an unknown value. For example, replacing a battery with a new battery may increase could change the value of the car according to a formula such as the following: the value after replacing a battery could be determine by a formula such as: (Range in miles of new battery−range in miles of old battery*$60). The actual formulas used will likely incorporate a large set of additional related variables, such as charge speed, and other battery attributes

In some instances, a market value of a vehicle can be assessed through independent sources, for model refinement or “training.” The model can use actual real selling points of vehicles as gathered through public or private sources, as well as the range of available data on these vehicles to adjust and tune the valuation models. Quantitative models for predicting value of the vehicle can be created based on telemetry and categorized third party activities to, among other valuations, determine depreciation between any two times instances of the vehicle, or determine “usage depreciation/appreciation” of a vehicle based on behavioral usage. For instance, if someone drives 2300 miles in 5 days, and the sunroof is open while it is raining for 2 days, the usage value may be negative $900 based on the model. As another example, if someone rents a vehicle and drives 6 miles in 30 minutes and fill the battery at the end, the usage value may be positive $7 based on the model.

The depreciation between two time instances can be used to price and facilitate financial transactions such as establishing rental fees. For example, instead of paying a fixed rate for the vehicle prior to rental, a renter can agree to pay for the depreciation caused by vehicle usage during period of rental. The depreciation can also be used to establish leasing fees, to determine a more accurate depreciation during period of lease, rather than fixed rate based on mileage. The depreciation can also be used to establish a sales price for the vehicle, and/or insurance fees based on vehicle replacement costs.

Beyond the actual depreciation between time instances, potential maximum and minimum values over time as dictated by the model could be used to price and facilitate financial transactions such as the following: down payment requirements amounts for sale or leasing. So for example if an extremely fast car could be depreciated $20 k by racing style activities, a higher percentage down payment may be dictated than for a similar car without the ability to do fast racing style activities.

Beyond assessing real-time market values based on a vehicle's data, this information can be used to facilitate various service agreements. For example, a tire-service provider may be granted access to view tire pressure and odometer data. The tire-service provider can accurately determine the state of the vehicle's tires (are they properly filled, do they need a rotation or replacement, etc.). With this information, they will be able to provide recommendations for various service activities to take place, and can then verify that this activity was completed. Another service-agreement may be real-time insurance quotes, based on a person's historical driving behavior related data. The insurance provider will be able to provide real-time quotes, as well as provide verification of coverage. Another application may be relating to vehicle financing. A financial provider may create data-driven financing and lease plans that accurately cover the real-time depreciation of the vehicle.

Utilization of smart-contracts: Many of the above transactions may be facilitated through smart-contracts based on a blockchain. These will provide programmatic monitoring and execution of agreed-upon terms, based on the vehicle data in real-time. For example, a financial provider may elect to charge the vehicle user based on the model's true depreciation costs. The smart contract will examine the vehicle data and then ensure that the transaction is programmatically completed in a fair, transparent, and secure manner. More simply, a financial provider may decide to charge on a per mile basis in real time as the vehicle is being used.

A further application may relate to the sharing of vehicles, between any number of arbitrary parties. Involved parties may include individuals, companies, or groups. Two parties may agree to exchange an amount valued in relation to the value of the depreciation experienced by the vehicle. For example, Person A lends Person B their vehicle for the day, at a price subject to real costs. The data is then processed and incorporated in the depreciation model, where the loss of value is determined and expensed, possibly with an agreed-upon multiplier, to the renter in a programmatic fashion through smart-contracts.

Market data on actual car sales and other available data can be used to improve the valuation model on an ongoing and iterative basis. Actual sales data may include only course data (i.e. year, mileage, etc.), or may include rich historical data in cases where this is available. For example, data from CarFAX or Tesla certified previously owned (CPO) can be queried, and year, mileage, features, and condition of a vehicle that sold can be examined. This data can be used as a market baseline for the vehicle value.

At 210, at least one of the models is executed by the system to establish a value of the vehicle, particularly at a point in time, based on the vehicle telemetry data and the non-vehicle data. For instance, predictive models can be used to determine the potential future cash flow of a car (i.e. how many more years can it shuttle people around town for pay), and thus determine if potential cash-flow from the car may affect its market value.

In some implementations, activities such as insurance, parking, or vehicle servicing, can be charged based on the telemetry feed by facilitating automated payments with a digital currency, such as a cryptocurrency like Etherium® or the like, as programmatically specified by a smart contract that processes sensor or telemetry data in real-time.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A computer-implemented method comprising:
receiving, by one or more processors of a vehicle valuation system, vehicle telemetry data collected by one or more sensors associated with the vehicle;
storing, by the one or more processors, the vehicle telemetry data in a blockchain stored in a database associated with the vehicle valuation system, one or more blocks of the blockchain having at least a portion of the vehicle telemetry data and a timestamp associated with the collection of the vehicle telemetry data;
accessing, by the one or more processors, one or more vehicle valuation models from a model store associated with the vehicle valuation system, each of the one or more vehicle valuation models including a telemetry-based evaluation component associated with the vehicle telemetry data and a time-based evaluation component associated with the timestamp; and
executing, by the one or more processors, at least one vehicle valuation model on the blockchain to generate a present value for the vehicle according to parameters associated with the at least one vehicle valuation model.

2. The method in accordance with claim 1, wherein the vehicle telemetry data includes at least one of a mileage and a speed of the vehicle.

3. The method in accordance with claim 1, further comprising receiving, by the one or more processors, time-based non-vehicle data related to an environment of the vehicle.

4. The method in accordance with claim 3, wherein the non-vehicle data includes weather data from a third party data system.

5. A computer-implemented method of tracking a value of a vehicle, the method comprising:
accessing, by one or more processors, a blockchain from a database, the blockchain being associated with the vehicle and having one or more blocks of data that represent time-based transactions by the vehicle;
receiving, by one or more processors, vehicle telemetry data collected by one or more sensors associated with the vehicle, and a first time-stamp associated with the vehicle telemetry data;
receiving, by the one or more processors, non-vehicle data related to an environment of the vehicle, and a second time-stamp associated with the non-vehicle data; and
storing, by the one or more processors, at least a portion of the received vehicle telemetry data and/or the non-vehicle data in a new block of the blockchain, the storing including storing the associated first time-stamp and/or second time-stamp;

6. The method in accordance with claim 5, wherein the vehicle telemetry data includes at least one of a mileage and a speed of the vehicle.

7. The method in accordance with claim 5, wherein the non-vehicle data includes weather data from a third party data system.

8. A computer-implemented method comprising
receiving, by one or more processors, vehicle telemetry data collected by one or more sensors associated with the vehicle, and a time-stamp associated with the vehicle telemetry data;
providing, by the one or more processors, the vehicle telemetry data to an electronic contract that specifies a service associated with the vehicle, the electronic contract further specifying a cost associated with the service, the cost being based on the vehicle telemetry data; and
transacting, by the one or more processors, a payment with a digital crypto-currency for the cost of the service in real-time according to the time-stamp.
